(19) United States
(12) Patent Application Publication
(10) Pub. No.: US 2011/0129235 A1
(43) Pub. Date: Jun. 2, 2011

(54) BURST-MODE OPTICAL SIGNAL RECEIVER

(75) Inventors: Quen Le, Gwangju-si (KR); Jong-deog Kim, Jellanam-do (KR); Mun-seob Lee, Daejeon-si (KR); Dong-soo Lee, Gwangju-si (KR)

(73) Assignee: Electronics and Telecommunications Research Institute, Daejeon-si (KR)

(21) Appl. No.: 13/056,216

(22) PCT Filed: Apr. 23, 2009
(86) PCT No.: PCT/KR2009/002125

§ 371 Date: Jan. 27, 2011

(30) Foreign Application Priority Data
Aug. 13, 2008 (KR) 10-2008-0079619

(51) Int. Cl. H04B 10/06

(52) U.S. Cl. 398/208

(57) ABSTRACT

A burst-mode optical receiver is provided. The burst-mode optical receiver includes a preamplifier, a post-amplifier integrated into one body together with the preamplifier, and an operation controller for controlling operation of the preamplifier and the post-amplifier using an external reset signal input from a single external reset input terminal. As a result, it is possible to implement a burst-mode receiver for a gigabit-capable passive optical network (GPON) in which a preamplifier unit and a post-amplifier unit are integrated.

### TECHNICAL FIELD

The present invention relates to a burst-mode optical signal receiver, and more particularly, to an optical receiver for an optical line terminal (OLT) based on a gigabit-capable passive optical network (GPON).

### BACKGROUND ART

In general optical communication, a point-to-point (P2P) scheme in which a transmitter and a receiver have a continuous data link is used. The receiver operates in response to input having a uniform intensity which does not vary according to time, and thus is required to have high sensitivity for long-distance communication. According to a point-to-multipoint (P2MP) scheme used in, for example, a PON, one OLT receives data in a burst packet format from a large number of optical network units (ONUS)/optical network terminals (ONTs) using the time division multiplexing (TDM) technique. Thus, the receiver is required to have high sensitivity while having a wide dynamic range and a rapid response characteristic for signal levels from a packet to packet. In this regard, various approaches have been tried.

In an Ethernet PON (EPON) standard (IEEE 802.3ah), no external reset signal for a burst-mode receiver is defined, and a long settling time of 512 bits is allowed at a data rate of 1.25 Gbps. On the other hand, according to a GPON standard providing relatively higher transmission efficiency (ITU-T G.984.x), a short settling time which is about a tenth of that of the EPON standard is required, and a reset signal provided by the media access control (MAC) layer can be used. Due to these differences between the GPON standard and the EPON standard, a burst-mode receiver for a GPON requires a more rapid settling response characteristic for a burst packet than a burst-mode receiver for an EPON.

Currently, there are a few 1.25 Gbps-class products for GPON burst-mode receivers, including VSC7718 transimpedance amplifier (TIA) and VSC7728 limiting amplifier (LA) of Vitesse Corp., and PAS7351 TIA and PAS7361 of PMC-Sierra Corp., and all the products are separated into TIAs (preamplifiers) and LAs (post-amplifiers). Optical subscriber networks employing technology for a 1.25 Gbps upstream burst-mode receiver based on the EPON or GPON standard are gradually spreading, and stan-dardization of 10G EPON (IEEE 802.3av) and 10G GPON (FSAN NG-PON) including 2.5 and 10 Gbps upstream burst-mode data rates is ongoing for next-generation optical subscriber networks. Therefore, a burst-mode receiver having a receiving rate of 2.5 Gbps or more will be required after a currently commercialized 1.25 Gbps burst-mode receiver.

### DISCLOSURE OF INVENTION

### Technical Problem

The present invention provides a burst-mode receiver satisfying upstream overhead requirements defined in gigabit-capable passive optical network (GPON) standards (ITU-T 984.2 and 984.3), and a method of efficiently controlling the burst-mode receiver using an external reset signal.

### Technical Solution

Additional aspects of the invention will be set forth in the description which follows, and in part will be apparent from the description, or may be learned by practice of the invention.

The present invention discloses a burst-mode optical signal receiver including: a preamplifier; a post-amplifier integrated into one body together with the preamplifier; and an operation controller for controlling operation of the preamplifier and the post-amplifier using an external reset signal input from a single external reset input terminal.

The preamplifier may include: a preamplifier unit for converting a current signal which is converted from a burst-mode optical signal into a voltage signal and amplifying the voltage signal; a gain controller for adjusting an amplification gain of the preamplifier unit; and a differential converter to convert the single-ended voltage signal output from the preamplifier unit into a differential signal at the outputs of the differential converter.

The preamplifier may further include a reference voltage signal output unit for outputting a reference voltage signal, and the gain controller may receive the voltage signal output from the preamplifier unit and the reference voltage signal output from the reference voltage signal output unit, compare the voltage signal and the reference voltage signal to obtain a difference therebetween, and adjust the amplification gain of the preamplifier unit.

The post-amplifier may include: a post-amplifier unit for amplifying the differential signals output from the differential converter; and a buffer for outputting the signals output from the post-amplifier unit through output terminals.

The post-amplifier unit may have an automatic offset adjustment function for adjusting an offset of the differential signals output from the differential converter.

It is to be understood that both the foregoing general description and the following detailed description are exemplary and explanatory and are intended to provide further explanation of the invention as claimed.

### BRIEF DESCRIPTION OF DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a block diagram of a burst-mode receiver for a gigabit-capable passive optical network (GPON) optical line terminal (OLT).

FIG. 2 is a waveform diagram of an external reset signal for the burst-mode receiver of FIG. 1.

FIG. 3 is a block diagram of a burst-mode receiver for a GPON according to an exemplary embodiment of the present invention.

FIG. 4 is a waveform diagram illustrating operation control using an external reset signal.

### MODE FOR THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art.

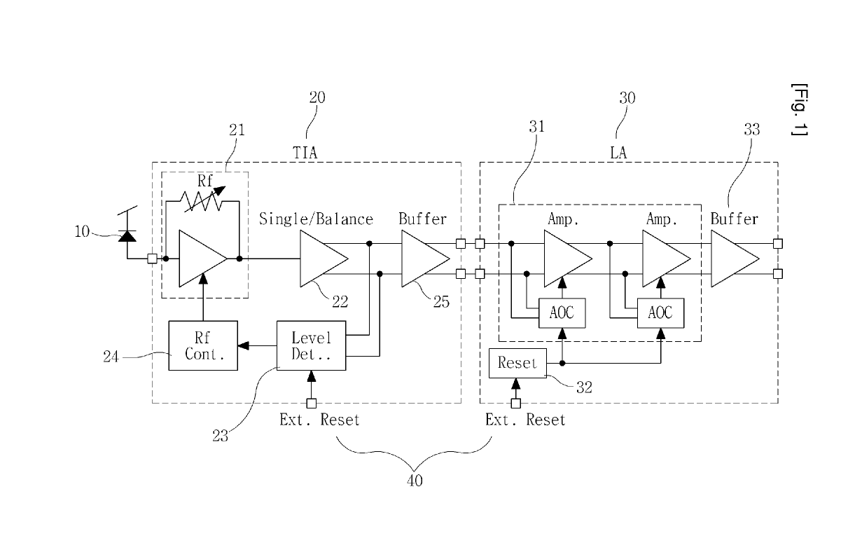

FIG. 1 is a block diagram of a burst-mode receiver for a gigabit-capable passive optical network (GPON) optical line terminal (OLT). The block diagram is shown in a paper written by Nakamura et al. (IEEE J Solid-State Circuits, Vol. 40, No. 12, p. 2680 2688) The receiver roughly includes a preamplifier, that is, a transimpedance amplifier (TIA) 20 which converts a current signal output from a photodiode (PD) 10 into a voltage signal and outputs the voltage signal, and a post-amplifier, that is, a limiting amplifier (LA) 30, which amplifies the voltage signal output from the TIA 20 and outputs the voltage signal having a uniform output level. The TIA 20 is an automatic gain control (AGC) device controlling gain according to the intensity of an input signal. The TIA 20 includes a TIA core 21, a single/balance block 22 which converts an output of the TIA core 21 into a differential signal, a detector 23 which senses the level of the input signal from the output of the single/balance block 22, a gain controller 24 which adjusts the gain of the TIA core 21 according to the input signal level sensed by the detector 23, and a buffer 25 for a signal output terminal of the TIA 20.

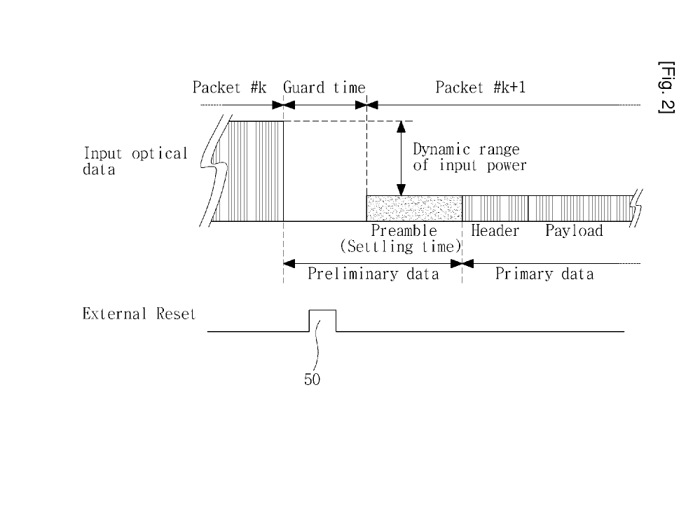

The LA 30 includes a block 31 which performs an automatic offset cancellation (AOC) function and an amplification function on signals input from the TIA 20 in two steps, a reset block 32, and a buffer 33 for an amplified signal output terminal. The waveform of an external reset signal 40 for the overhead of each burst packet is shown in FIG. 2. The external reset signal 40 is input to the detector 23 of the TIA 20 and the reset block 32 of the LA 30. As a result, the burst-mode receiver has a sensitivity of 30 dBm, a dynamic range of 26 dB or more, and a short settling time of 20 bits or less for a 1.25 Gbps GPON.

In a GPON for 1.25 or 2.5 Gbps upstream burst-mode data transmission and reception, an overhead time of about 77 ns including a guard time, a preamble and a delimiter is defined. A short settling time for a preamble pattern must be satisfied within a time excluding the minimum guard time of 25.7 ns and a recommended delimiter time of 20 bits.

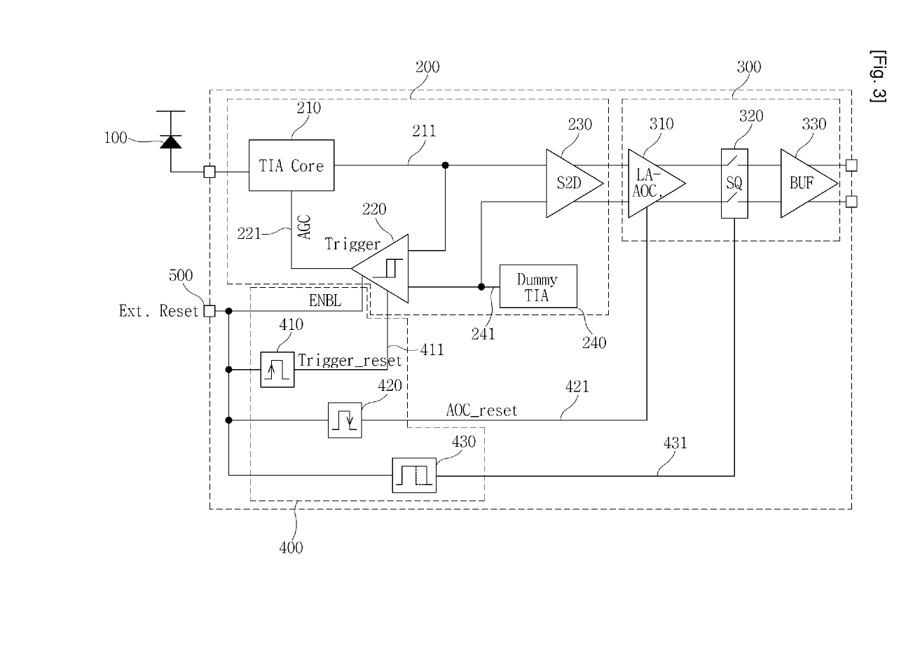

FIG. 3 is a block diagram of a burst-mode receiver for a GPON according to an exemplary embodiment of the present invention.

As illustrated in FIG. 3, the burst-mode receiver according to an exemplary embodiment of the present invention includes a preamplifier, that is, a TIA 200, a post-amplifier, that is, an LA 300, and an operation controller 400. The burst-mode receiver has a unique feature in that the TIA 200 and the LA 300 are integrated into one body. In addition, the burst-mode receiver has another unique feature in that operation of the TIA 200 and the LA 300 is controlled using an external reset signal 510 input through a single external signal input terminal 500. The burst-mode receiver having these features will be described in detail below.

The TIA 200 is an AGC device and includes a preamplifier unit 110, a gain controller 220, a reference voltage signal output unit 240, and a differential converter 230. A TIA core 210, that is, the preamplifier unit 110, receives a current signal converted from an optical signal by a photodiode 100, converts the current signal into a voltage signal 211, and performs gain amplification. In an exemplary embodiment, the TIA core 210 has a high-gain mode for a weak input signal and a low-gain mode for a strong input signal. It is determined by an AGC signal output from the gain controller 220 to which gain mode the TIA core 210 will be switched. The voltage signal 211 output from the TIA core 210 is input to the gain controller 220 and the differential converter 230. For reference, an AGC function is intended to allow a burst-mode receiver to have a wide dynamic range and cope with a high loud/soft ratio generated from an optical network unit (ONU)/optical network terminal (ONT) terminal having high optical loss and an ONU/ONT terminal having low optical loss.

The reference voltage signal output unit 240 outputs a reference voltage signal as input for the gain controller 220 and the differential converter 230. Here, the reference voltage signal output from the reference voltage signal output unit 240 is a dark level voltage signal which does not include data. The reference voltage signal output unit 240 according to an exemplary embodiment of the present invention has the same structure as a TIA and is a dummy TIA outputting a dark level voltage signal which does not include data.

The gain controller 220 is a trigger, preferably, a Schmitt trigger. The trigger 220, which senses the level of the input voltage signal 211 and operates as a comparator, outputs an AGC signal 221 for automatically controlling the gain mode of the TIA core 210 to the TIA core 210. The trigger 220 having a rapid response characteristic compares the input voltage signal 211 with a dark level voltage signal 241. When the intensity of the voltage signal 211 is a specific level or more, the trigger 220 generates an AGC-on signal. Otherwise, the trigger 220 generates an AGC-off signal. In an exemplary embodiment of the present invention, the AGC-on signal makes the TIA core 210 operate in the low-gain mode, and the AGC-on state can be stably maintained for a single burst packet time due to the hysteresis characteristic of the Schmitt trigger 220.

Meanwhile, a signal-to-differential (S2D), that is, the differential converter 230, converts a single line signal, which is automatically gain-controlled and output by the TIA core 210, into a differential line signal robust against noise. The S2D 230 is implemented by a differential amplifier circuit having low gain to prevent pulse width distortion. The S2D 230 receives the input voltage signal 211 including data and the dark level input voltage signal 241 not including data and outputs differential signals of a symmetrical structure including data.

A post-amplifier unit 310 has an amplification function of providing sufficient gain required for the receiver, and may additionally have an AOC function of canceling an offset between the differential signals. Since the differential signals output from the S2D 230 are symmetrical but have a large offset, it is necessary to amplify the signals after minimizing the offset. The AOC function includes a function of detecting the peak of a signal and adjusting an offset between signals, and the peak detection function needs to be reset for initialization at an appropriate point in time for each burst packet. An LA-AOC, that is, the post-amplifier unit 310, amplifies and outputs input signals such that a voltage difference between both terminals is minimized.

An output delayer 320 delays the signals output from the LA-AOC 310 to settle them enough and then output them. In an exemplary embodiment, the output delayer 320 is a Squench (SQ) device. A buffer 330 finally outputs the signals delayed by the SQ 320 to outside. The buffer 330 may change signal levels with a signal level appropriate for high-speed serial interface, for example, a current mode logic (CML), and output the signals. For reference, the burst signals output from the buffer 330 are transferred to a clock data recovery (CDR), and the CDR rapidly recovers data and a clock from the burst signals.

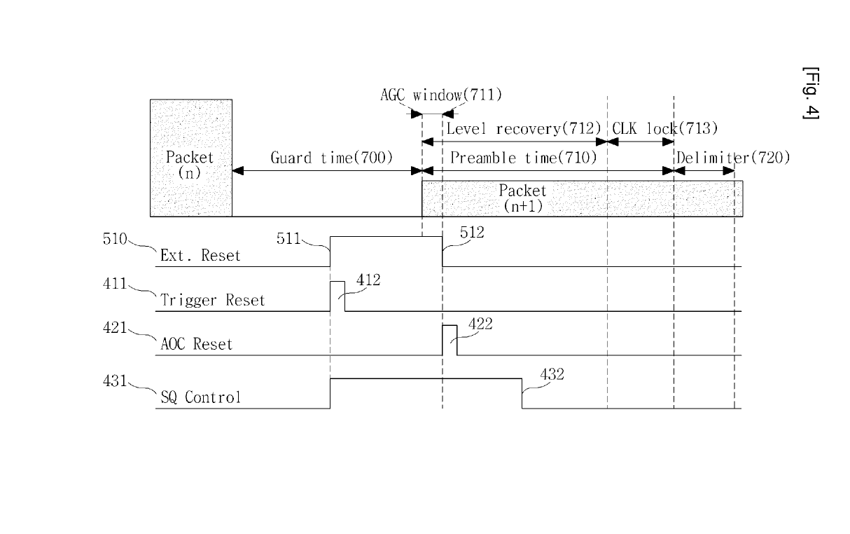

The operation controller 400 controls operation of the TIA 200 and the LA 300 using the external reset signal 510 input through the single external signal input terminal 500. This will be described with reference to FIG. 4. FIG. 4 is a waveform diagram of the external reset signal 510 for controlling the burst-mode receiver and internal reset signals for internal control generated according to the external reset signal 510 in the overhead time of a burst packet. A burst mode overhead time for an OLT defined in a GPON standard (G.984.2 Table 1.2) includes a guard time 700 between burst packets, a preamble time 710, and a delimiter time 720. The external reset signal 510 is provided by the media access control (MAC) layer, which is an upper layer of the physical layer for communication, and the waveform of an external reset signal for controlling burst-mode components of the physical layer is not defined in the standard. In order to efficiently control the burst-mode receiver shown in FIG. 3, an exemplary embodiment of the present invention suggests the waveform of the external reset signal 510, internal reset signals 411 and 421 interoperating with the external reset signal 510, and a control signal 431. As illustrated in FIG. 4, the preamble time 710 is divided into an AGC window section 711, a level recovery section 712 including the AGC window section 711 and a CLK lock section 713, and its relationship with the external reset signal 510 will be described below.

The waveform of the external reset signal 510 according to an exemplary embodiment of the present invention has a rising edge 511 in the guard time 700, and a falling edge 512 at the beginning of the preamble time 710. The external reset signal 510 is input as an enable signal ENBL for activating the trigger 220. Thus, an AGC switching function of the trigger 220 can be performed only between the rising edge 511 and the falling edge 512. The falling edge 512 of the external reset signal 510 must be determined to ensure the minimum time required for the activated trigger 220 to perform AGC. In the preamble time 710, the falling edge 512 may be positioned apart by a time taken for AGC from the start point of a preamble signal. The position of the falling edge 512 determines the AGC window 711. In the AGC window 711, the gain mode of the TIA core 210 is determined according to the intensity of a signal input from the photodiode 100, and the enable signal ENBL 510 prevents the AGC switching function from being performed in a burst packet section behind the AGC window 711 under any circumstances.

Meanwhile, a first resetting unit 410 of the operation controller 400 resets the trigger 220 according to the external reset signal 510. The first resetting unit 410 according to an exemplary embodiment of the present invention generates a pulse 412 synchronized with the rising edge 511 of the external reset signal 510 and outputs it to the trigger 220, thereby resetting the trigger 220. Referring to the waveform of the trigger reset signal 411, the trigger reset signal 411 includes the pulse 412 generated by the first resetting unit 410 in synchronization with the rising edge 511 of the external reset signal 510. The trigger reset signal 411 initializes the trigger 220 in an off state during the guard time 700 such that the TIA core 210 and the trigger 220 can prepare to select a gain mode corresponding to a burst packet newly input in the AGC window 711.

A second resetting unit 420 resets the AOC function of the LA-AOC 310 according to the external reset signal 510. The second resetting unit 420 according to an exemplary embodiment of the present invention generates a pulse 422 synchronized with the falling edge 512 of the external reset signal 510. Referring to the waveform of the AOC reset signal 421, the AOC reset signal 421 includes the pulse 422 generated by the second resetting unit 420 in synchronization with the falling edge 512 of the external reset signal 510. The second resetting unit 420 outputs the AOC reset signal 421 to the LA-AOC 310 to reset the AOC function. The AOC function is reset for the following reason. When the intensity of a signal input to the TIA core 210 is high, the output amplitude of the TIA 200 is large at the beginning of the AGC window 711. At this time, the trigger 220 outputs the AGC-on signal in a previous reset state, i.e., AGC off, and thus the TIA core 210 operates in the low-gain mode. Therefore, the output amplitude of the TIA 200 is remarkably reduced. However, before AGC on, that is, at the beginning of the AGC window 711, the high output of the TIA 200 is transferred to the LA-AOC 310 via the S2D 230, and peak detection output for the AOC function is fixed in a specific state. As a result, a lock phenomenon in which the required AOC function is not performed may occur after AGC on. To avoid such a problem, the AOC function may be reset after AGC switching.

A delay controller 430 delays the output of the SQ 320 according to the external reset signal 510. The delay controller 430 according to an exemplary embodiment of the present invention is a pulse extender which generates a pulse obtained by extending the falling edge 512 of the external reset signal 510 for a specific time. Referring to the waveform of the SQ control signal 431, the delay controller 430 delays a falling edge 432 behind the falling edge 512 of the external reset signal 510. The SQ control signal 431 controls the burst-mode receiver to be settled enough in the level recovery section 712 and then to output an amplified signal. This enables the CDR to extract a stable clock in the CLK lock section 713 at the beginning of a burst packet without being affected by an unstable signal provided by the burst-mode receiver.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

According to an exemplary embodiment of the present invention, a burst-mode receiver which can be used in a GPON OLT requiring upstream burst-mode data reception at a data rate of several Gbps or more can be efficiently configured. In addition, it is possible to implement a receiver which has a rapid response characteristic and is capable of accurate operation for burst packets having various input intensities.

1. A burst-mode optical signal receiver, comprising:
a preamplifier;
a post-amplifier integrated into one body together with the preamplifier; and
an operation controller for controlling operation of the preamplifier and the post-amplifier using an external reset signal input from a single external reset input terminal.

2. The burst-mode optical signal receiver of claim 1, wherein the preamplifier includes:
a preamplifier unit for converting a current signal which is converted from a burst-mode optical signal into a voltage signal and amplifying the voltage signal;
a gain controller for adjusting an amplification gain of the preamplifier unit; and
a differential converter for converting the voltage signal output from the preamplifier unit into a differential signal.

3. The burst-mode optical signal receiver of claim 2, wherein the preamplifier further includes a reference voltage signal output unit for outputting a reference voltage signal, and the gain controller receives the voltage signal output from the preamplifier unit and the reference voltage signal output from the reference voltage signal output unit, compares the voltage signal and the reference voltage signal to obtain a difference therebetween, and adjusts the amplification gain of the preamplifier unit.

4. The burst-mode optical signal receiver of claim 3, wherein the reference voltage signal output unit is a dummy preamplifier having the same constitution as the preamplifier and outputting a dummy reference voltage signal.

5. The burst-mode optical signal receiver of claim 3, wherein the differential converter receives the voltage signal output from the preamplifier unit and including effective data and the reference voltage signal output from the reference voltage signal output unit and not including effective data, and outputs differential signals of a symmetrical structure including effective data.

6. The burst-mode optical signal receiver of claim 3, wherein when the difference between the voltage signal and the reference voltage signal is a specific value or more, the gain controller outputs an automatic gain control (AGC)-on signal to the preamplifier unit such that the preamplifier unit having a high-gain mode and a low-gain mode operates in the low-gain mode.

7. The burst-mode optical signal receiver of claim 3, wherein the gain controller is a Schmitt trigger.

8. The burst-mode optical signal receiver of claim 3, wherein the external reset signal has a rising edge in a guard time section of the burst-mode optical signal and a falling edge in a preamble section.

9. The burst-mode optical signal receiver of claim 8, wherein the external reset signal is input through an enable terminal of the gain controller.

10. The burst-mode optical signal receiver of claim 9, wherein the operation controller includes:
a first resetting unit for receiving the external reset signal and resetting the gain controller.

11. The burst-mode optical signal receiver of claim 10, wherein the first resetting unit generates a pulse synchronized with the rising edge of the external reset signal and outputs the pulse to the gain controller to reset the gain controller.

12. The burst-mode optical signal receiver of claim 11, wherein the falling edge of the external reset signal is positioned at a point in time corresponding to a time required for adjusting the amplification gain of the preamplifier unit.

13. The burst-mode optical signal receiver of claim 3, wherein the post-amplifier includes:
a post-amplifier unit for amplifying the differential signals output from the differential converter; and
a buffer for outputting the signals output from the post-amplifier unit through output terminals.

14. The burst-mode optical signal receiver of claim 13, wherein the post-amplifier unit has an automatic offset adjustment function for adjusting an offset of the differential signals output from the differential converter.

15. The burst-mode optical signal receiver of claim 14, wherein the operation controller includes:
a second resetting unit for receiving the external reset signal and resetting the automatic offset adjustment function of the post-amplifier unit.

16. The burst-mode optical signal receiver of claim 15, wherein the second resetting unit generates a pulse synchronized with a falling edge of the external reset signal and outputs the pulse to the post-amplifier unit to reset the automatic offset adjustment function of the post-amplifier unit.

17. The burst-mode optical signal receiver of claim 13, wherein the buffer changes levels of the signals output from the post-amplifier unit with a signal level appropriate for high-speed serial interface and outputs the signals.

18. The burst-mode optical signal receiver of claim 13, wherein the post-amplifier further includes:
an output delayer for outputting the signals output from the post-amplifier unit to the buffer after the signals are settled.

19. The burst-mode optical signal receiver of claim 18, wherein the operation controller includes:
a delay controller for receiving the external reset signal and delaying the output of the output delayer.

20. The burst-mode optical signal receiver of claim 19, wherein the delay controller delays the output of the output delayer such that the buffer generates the stable output before a section for clock extraction in a preamble section of a burst packet.

21. The burst-mode optical signal receiver of claim 20, wherein the delay controller receives the external reset signal, generates an extension pulse by delaying a falling edge of the external reset signal, and outputs the generated extension pulse to the output delayer in order to delay the output of the output delayer.
